(19) United States
(12) Patent Application Publication
(10) Pub. No.: US 2026/0335992 A1
(43) Pub. Date: Oct. 29, 2026

(54) TOOL BODY OF A CUTTING TOOL, AND CORE MEMBER FOR THE TOOL BODY

(71) Applicant: TUNGALOY CORPORATION, Fukushima (JP)

(72) Inventor: Hiroya SHIKAMA, Fukushima (JP)

(73) Assignee: TUNGALOY CORPORATION, Fukushima (JP)

(21) Appl. No.: 19/660,835

(22) Filed: Apr. 28, 2026

(30) Foreign Application Priority Data
Apr. 28, 2025 (JP) 2025-074126

(51) Int. Cl. B23C 5/10

(52) U.S. Cl. CPC B23C 5/10; B23C 2210/02

(57) ABSTRACT

A tool body of a cutting tool includes: a core fitting part into which a core member is fitted along the central axis of the tool body; and a fastening device that fastens the core member fitted in the core fitting part to the tool body. The core member has a contact surface which comes into contact with the fastening device. The contact surface is provided on the outer surface of the core member so as to face outward with an inclination relative to a virtual plane that is perpendicular to the central axis of the core member. The fastening device presses the outer surface of the core member in an angled direction relative to a virtual plane that is perpendicular to the central axis of the core member.

### BACKGROUND

### Field

The present invention relates to a tool body of a cutting tool, and a core member for the tool body.

### Description of Related Art

A known example of a conventional drilling tool used for making a large diameter hole is configured such that an insert serving as the center cutting edge of the tool is mounted to an insert seat that is integrally formed with the tool head (see, for example, U.S. Pat. Nos. 8,376,669 B and 10,967,441 B). In another example of such drilling tools, an insert serving as the center cutting edge is mounted to an insert seat which is provided in the form of a cartridge (see, for example, U.S. Pat. Nos 7,244,081 B and 9,643,259 B). For drilling tools used for making a particularly large diameter hole, tools having a solid drill disposed at the center of the tool, in combination with some additional inserts, are also known.

However, improvement may still be made for such conventional drilling tools in terms of fastening the member serving as the center cutting edge with enhanced strength and rigidity.

### SUMMARY

In view of the above-described circumstances, an object of the present invention is to provide a tool body of a cutting tool, and a core member for the tool body, whereby a member serving as a center cutting edge can be more firmly and rigidly fastened to the tool body.

In an aspect of the present invention, a core member is provided that is removably attachable to a tool body of a cutting tool, the core member having a contact surface which comes into contact with a fastening device for fastening the core member to the tool body, wherein the contact surface is provided on the outer surface of the core member so as to face outward with an inclination relative to a virtual plane that is perpendicular to the central axis of the core member.

With the above-described core member, since the contact surface that comes into contact with a fastening device for fastening the core member to the tool body is inclined, a component of force acting in a direction along the central axis will be generated, so that the core member, and a member (cutting insert) mounted to the core member to serve as the center cutting edge, can be fastened with enhanced strength and rigidity.

In the above-described core member, the contact surface may be inclined so as to face toward the leading end portion of the core member.

In the above-described core member, the contact surface may be provided on the base end side of the core member.

In the above-described core member, a helical groove may be formed on the outer surface.

The above-described core member may be cylindrical in shape.

In the above-described core member, an insert seat may be provided in the leading end portion of the core member for mounting a cutting insert to the insert seat.

In the above-described core member, one or more insert seats may be arranged so as to surround the central axis.

The above-described core member may be a drill.

In the above-described core member, the contact surface may come into contact with a fastening device for fastening the core member to the tool body in a state where the core member is fitted into a core fitting part of the tool body along the central axis of the tool body.

In the above-described core member, the contact surface may be formed of a flat surface.

In the above-described core member, the contact surface may be formed of a surface which is at least partly curved.

In the above-described core member, an angle formed by the central axis of the core member and a perpendicular line to the contact surface may be 45 degrees or more and less than 90 degrees on a virtual plane defined by the central axis and the perpendicular line.

In the above-described core member, an angle formed by the central axis of the core member and a perpendicular line to the contact surface may be 74 degrees or more and 76 degrees or less on a virtual plane defined by the central axis and the perpendicular line.

According to another aspect of the present invention, a tool body of a cutting tool is provided wherein a cutting insert and a drill are removably attachable to the tool body, the tool body including: a core fitting part into which a core member having a cutting edge is fitted along the central axis of the tool body; and a fastening device that fastens the core member fitted in the core fitting part to the tool body, wherein the fastening device presses the outer surface of the core member in an angled direction relative to a virtual plane that is perpendicular to the central axis of the core member.

With the above-described tool body, since the fastening device presses the outer surface of the core member in an angled direction relative to a virtual plane that is perpendicular to the central axis of the core member, this generates a component of force acting in a direction along the central axis, allowing the core member to be more firmly and rigidly fastened to the tool body.

In the above-described tool body, a drill may be provided in the leading end portion of the tool body.

The above-described tool body may further include a through-hole through which the fastening device is inserted.

In the above-described tool body, the through-hole may be inclined toward the leading end portion as it extends radially outward of the tool body.

The above-described tool body may have a helical chip discharge groove formed on the outer surface of the tool body.

In the above-described tool body, an angle formed by the central axis and the center line of the through-hole may be 45 degrees or more and less than 90 degrees on a virtual plane defined by the central axis and the center line.

In the above-described tool body, an angle formed by the central axis and the center line of the through-hole may be 74 degrees or more and 76 degrees or less on a virtual plane defined by the central axis and the center line.

In the above-described tool body, the core fitting part may be provided along the central axis and a plurality of insert seats may be arranged radially outward of the core fitting part.

According to a further aspect of the present invention, a cutting tool having a core member and a tool body as described above is provided.

In the above-described cutting tool, an angle formed by the central axis and the center line of the through-hole may be the same as an angle formed by the central axis and a perpendicular line to the contact surface on a virtual plane defined by the central axis and the center line.

### BRIEF DESCRIPTION OF DRAWINGS

FIG. 1 is a perspective view illustrating a cutting tool according to an embodiment of the present invention.

FIG. 2 is a perspective view illustrating an example of a drill head (tool body) of a cutting tool.

FIG. 3 is a perspective view illustrating an example of a core member that is removably attachable to a drill head.

FIG. 4A is an exploded perspective view illustrating a drill head, a core member, a cutting insert, and others.

FIG. 4B is a perspective view illustrating a cutting insert.

FIG. 5 illustrates a drill head and other members as viewed from the leading end side.

FIG. 6A is a sectional view of the drill head and other members in FIG. 5, cut along the line VI-VI in FIG. 5.

FIG. 6B is an enlarged partial view of FIG. 6A.

FIG. 7 is a perspective view illustrating an example of a core member.

FIG. 8 illustrates a core member as viewed from the leading end side.

FIG. 9 illustrates a core member as viewed from the side surface.

### DETAILED DESCRIPTION

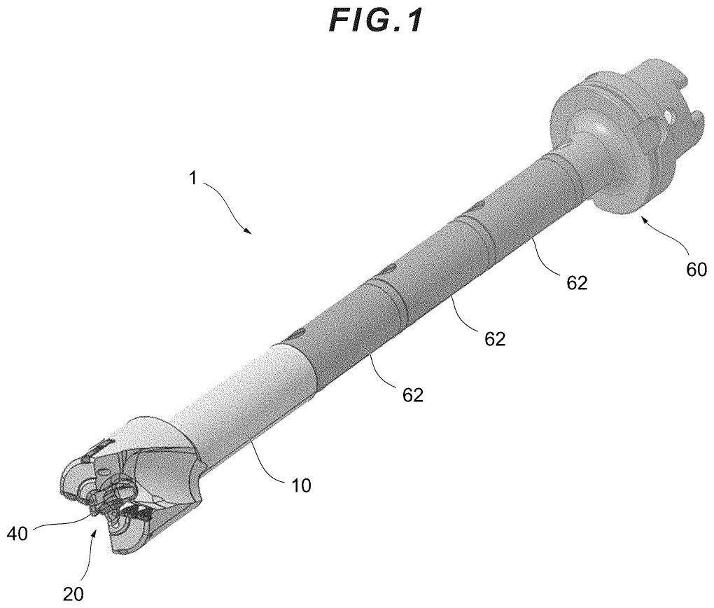

Preferred embodiments of a tool body of a cutting tool and a core member for such tool body according to the present invention will now be described in detail, with reference to the attached drawings (see FIG. 1, etc.).

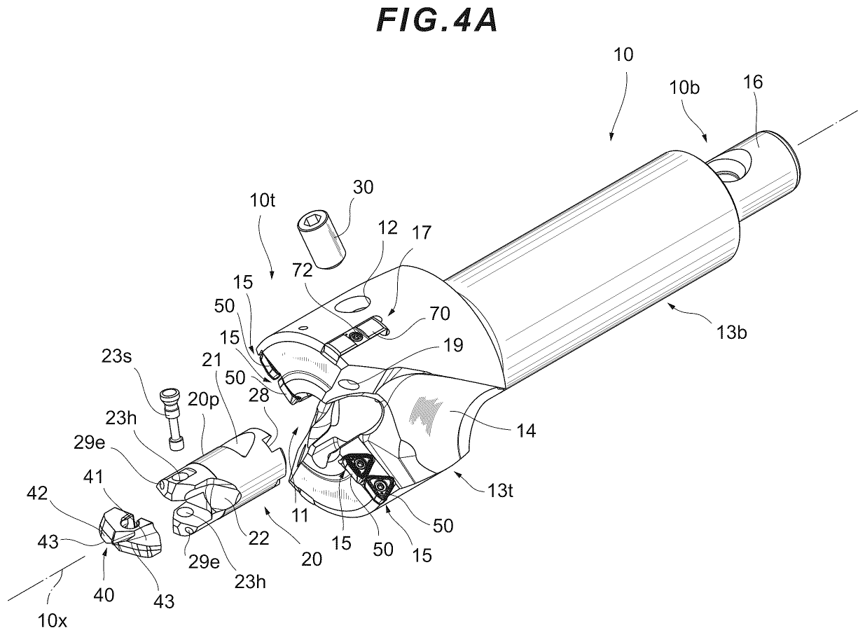

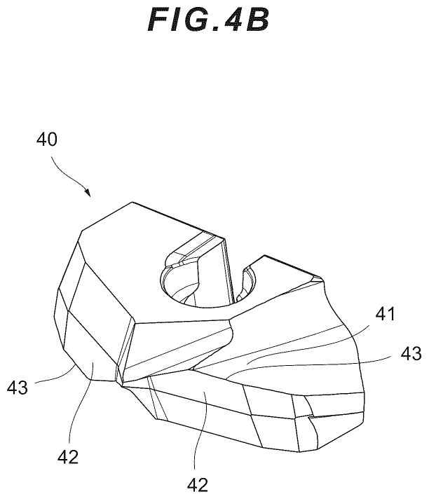

As an example of preferred embodiments of the present invention, a drilling tool 1 will be described below (see FIG. 1, etc.). The drilling tool 1 of the present embodiment is configured as a tool which may have, e.g., a tool body 10, a core member 20 removably attachable to the tool body 10, and a fastening device 30 (see FIG. 4A, etc.).

### Tool Body

The tool body 10 is formed as a member which is configured so that a cutting insert 50 and a drill can be removably mounted/attached to the tool body, and it functions as a drill head when the cutting tool is configured as a drilling tool 1 as in the present embodiment. The tool body 10 of this embodiment is shaped so that it extends from the base end portion 10b to the leading end portion 10t along the central axis 10x. The tool body 10 may include, for example, a core fitting part 11, a through-hole 12, an outer surface 13, a chip discharge groove 14, an insert seat 15, an extension connecting part 16, a guide pad mounting part 17, and a coolant supply path 18 (see FIG. 4A, etc.).

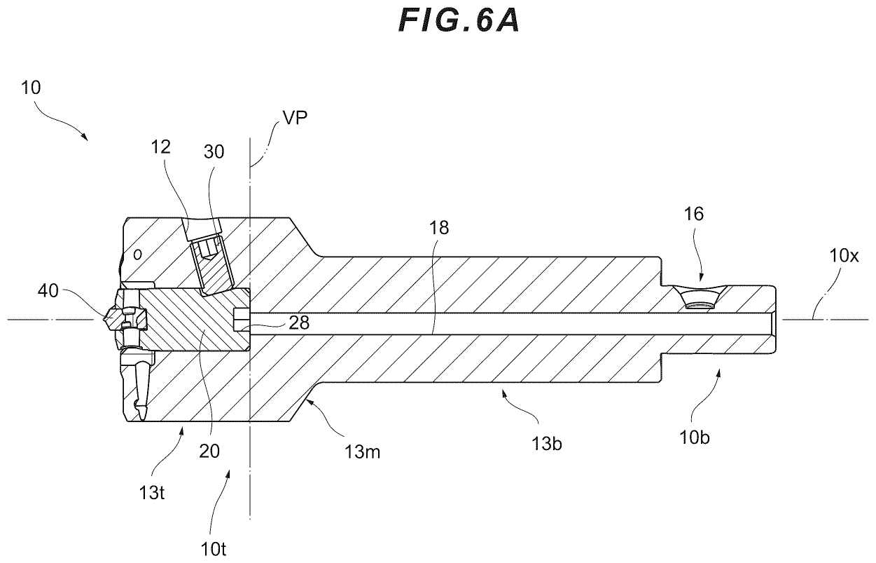

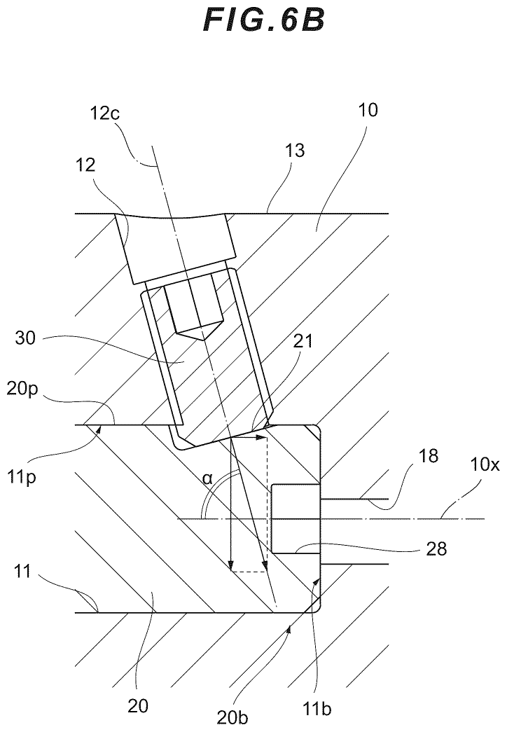

The core fitting part 11 is provided at the leading end portion 10t of the tool body 10 so that the core member 20 is fitted therein along the central axis 10x. The core fitting part 11 is formed so as to agree with the outer shape of the core member 20. For example, according to the cylindrical shape of the core member 20, the core fitting part 11 may be shaped in a circular hole, having an inner surface 11p formed along the central axis 10x, and a bottom surface 11b which comes into contact with a base end portion 20b of the core member 20 (see FIG. 6A, etc.). The core member 20 fitted into the core fitting part 11 is fastened to the tool body 10 with the fastening device 30 (see FIG. 6A, etc.).

The through-hole 12 is provided as a hole for setting the fastening device 30, such as by allowing the fastening device 30 to pass through the hole. The through-hole 12 may have a variety of forms according to specific examples of the fastening device 30. For example, in the present embodiment, a fastening screw is used for the fastening device 30, and the through-hole 12 therefore has an internal thread formed on its inner surface so as to engage with the fastening screw (see FIG. 4A, etc.). Further, in the present embodiment, the center line 12c of the through-hole 12 is angled relative to the central axis 10x, and the through-hole 12 is inclined toward the leading end portion 10t of the tool body 10 as it extends radially outward of the tool body 10. The through-hole 12 is further configured such that it extends from the outer surface 13 of the tool body 10 through to the inner surface 11p of the core fitting part 11 (see FIG. 6A, etc.). When the fastening device 30 is passed through such angled through-hole 12 and presses a contact surface 21 formed on the outer surface of the core member 20, a component of force will act on the core member 20 in a direction along the central axis 10x, as well as a force acting in the radial direction. With this configuration, the fastening device 30 can apply not only the force that presses the core member 20 against the inner surface 11p, but can also apply the force that presses the core member 20 along the central axis 10x against the bottom surface 11b of the core fitting part 11, and as a consequence, the fastening device 30 can achieve stronger and more rigid fastening and holding of the core member 20 by axially pushing the core member 20 toward the base end portion 10b and thrusting it against the bottom surface 11b (see FIG. 6B, etc.). The angle α formed between the central axis 10x of the tool body 10 and the center line 12c of the through-hole 12 is not particularly limited, as long as the above-described structure is realized. From the perspective of obtaining the above-mentioned functionality, such angle α is preferably 45 degrees or more and less than 90 degrees, and more preferably 74 degrees or more and 76 degrees or less, on a virtual plane defined by the central axis 10x and the center line 12c.

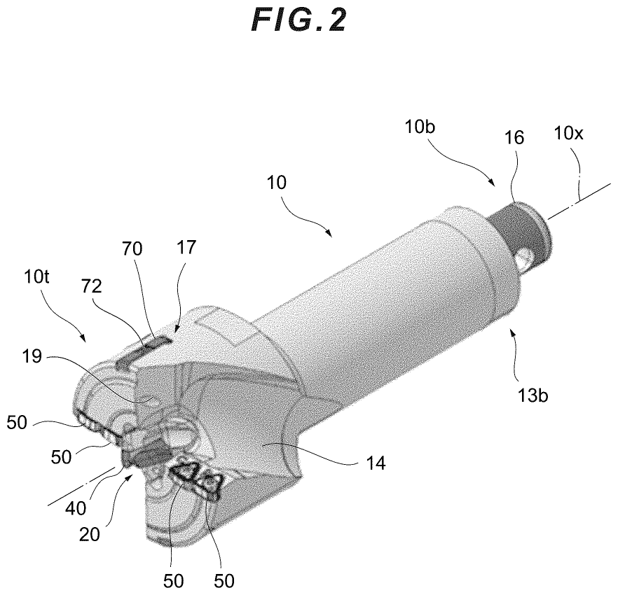

The outer surface 13 of the tool body 10 includes a large-diameter part 13t which is closer to the leading end portion 10t, a small-diameter part 13b which is closer to the base end portion 10b, and a tapered part 13m which connects between the large-diameter part 13t and the small-diameter part 13b (see FIG. 2, etc.). The through-hole 12 is opened on the surface of the large-diameter part 13t (see FIGS. 6A and 6B).

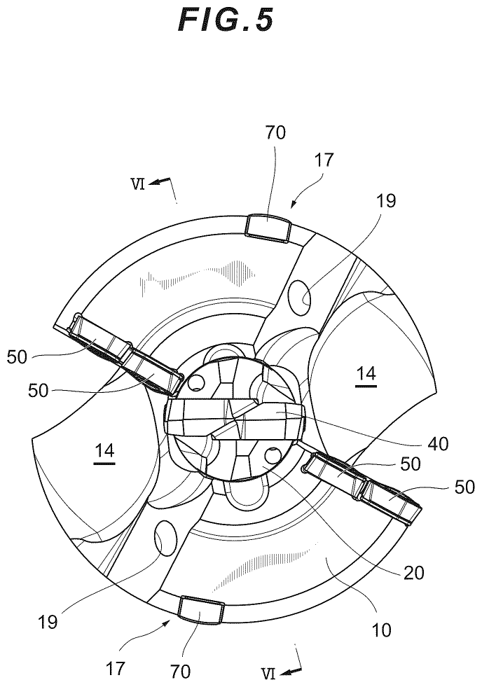

The chip discharge groove 14 is a groove for allowing chips generated during cutting to be removed together with coolant. The tool body 10 of this embodiment has a pair of helical chip discharge grooves 14 formed on the outer surface 13, and such two grooves 14 are axially symmetrical around the central axis 10x (see FIG. 5, etc.).

The insert seat 15 is provided as a seat for mounting a cutting insert 50 to the tool body 10. The specific form of such insert seat 15 and the specific form of the cutting insert 50 mounted thereon are not particularly limited. A plurality of insert seats 15 may be provided radially outward of the core fitting part 11. As an example, in the present embodiment, a total of four insert seats 15 are arranged diametrically in a line, with two of them on each side with respect to the central axis 10x (see FIG. 5, etc.). A cutting insert 50 is mounted on each of the insert seats 15 in a predetermined orientation (see FIG. 2, etc.).

The extension connecting part 16 serves as a portion for connecting an extension 62 to the tool body 10 (see FIGS. 1 and 2, etc.). Although not shown in the drawings, an adapter 60 may be directly attached to the extension connecting part 16, without having an extension 62.

The guide pad mounting part 17 is a portion provided for mounting a guide pad 70. The guide pad 70 is a member that serves as a guide while a workpiece is being cut by a cutting insert 50, etc., by way of making contact with the inner wall of a hole created in the workpiece through cutting. The guide pad 70 is mounted to the guide pad mounting part 17 and fastened and affixed to a side (outer surface 13) of the tool body 10 with a fastening screw 72 (see FIG. 2, etc.).

The coolant supply path 18 is a flow path provided for supplying coolant to a cutting edge located at the leading end of the drilling tool 1 (e.g., a cutting edge of a cutting insert 40 forming the center cutting edge). In the tool body 10 of the present embodiment, a circular coolant flow path 18 is formed inside the tool body 10 and extends straight along the central axis 10x from the base end portion 10b to the leading end portion 10t (see FIGS. 6A and 6B). The leading end portion 10t side of the coolant flow path 18 is opened at the bottom surface 11b of the core fitting part 11, from which coolant is supplied toward a coolant groove 28 of the core member 20.

### Core Member

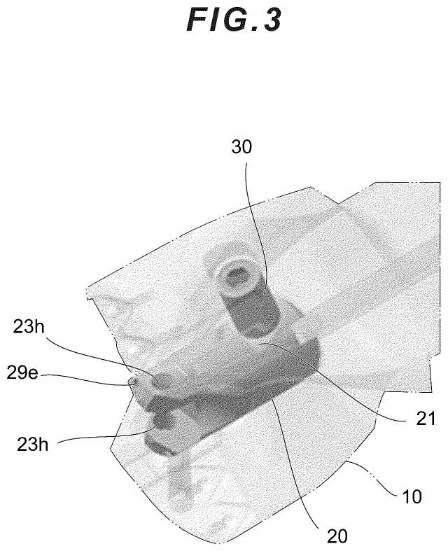

The core member 20 is a steel member (steel body) that is removably attachable to the core fitting part 11 of the above-described tool body 10 (see FIGS. 3-9). Examples of the core member 20 may include a member having an integrated cutting edge at a leading end thereof, which is often called a “solid drill,” as well as an indexable member and a head-replaceable member. By way of example, the present embodiment describes a core member 20 having a head-replaceable configuration. The core member 20 of the present embodiment is in a substantially cylindrical or hollow-cylindrical shape and extends along the central axis 20x. The core member 20 may include, for example, a contact surface 21, a helical groove 22, an insert seat 23, a coolant groove 28, and a coolant flow path 29.

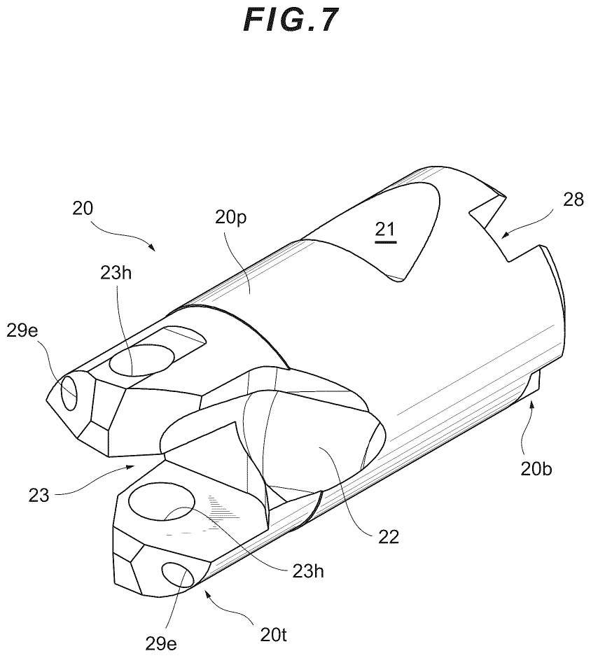

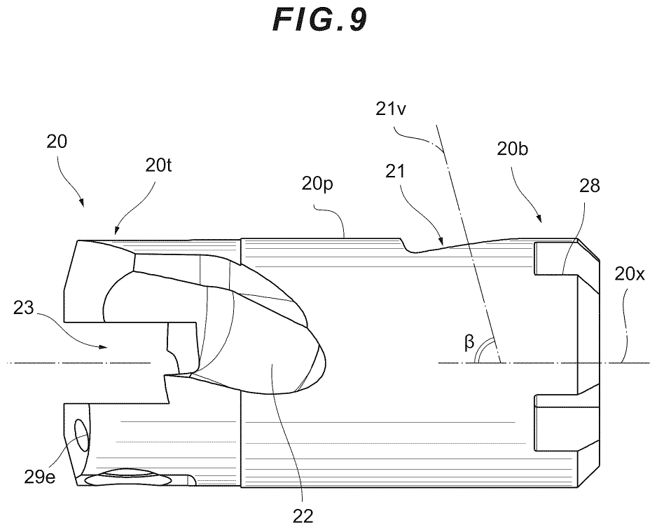

The contact surface 21 is formed as a surface which comes into contact with a portion of the fastening device 30. In the present embodiment, a portion of the outer surface 20p of the core member 20 is cut, and the contact surface 21 is formed in such cut portion (see FIG. 7, etc.). The core member 20 is fitted into the core fitting part 11 along the central axis 10x of the tool body 10 and, in this state, a portion of the fastening device 30 is brought into contact with the contact surface 21, thereby fastening the core member 20 to the tool body 10 (see FIG. 3, etc.). The contact surface 21 is inclined relative to a virtual plane (as indicated by the letters VP in FIG. 6A) which is perpendicular to the central axis 20x of the core member 20, and such contact surface 21 faces outward toward the leading end portion 20t of the core member 20 (see FIG. 9, etc.). The contact surface 21 is desirably configured so that the angle β formed by the central axis 20x of the core member 20 and the perpendicular line 21v to the contact surface 21 is 45 degrees or more and less than 90 degrees on a virtual plane defined by the central axis 20x and the perpendicular line 21v (for such virtual plane, please see the cross-section as illustrated in FIG. 6B, and also see FIG. 9). An example of the preferable range of the angle β may be 74 degrees or more and 76 degrees or less.

In the present embodiment, the above-described contact surface 21 is formed at a location close to the base end portion 20b of the core member 20 (see FIG. 7, etc.). However, this is merely an example, and the contact surface 21 may conversely be formed at a location close to the leading end portion 20t. Alternatively, the contact surface 21 may be formed around the longitudinally middle section along the central axis 20x. The contact surface 21 in the present embodiment is a flat surface (see FIG. 9, etc.); however, the contact surface 21 may be, for example, a surface which is at least partly curved. Although not shown in the drawings, the contact surface 21 may be formed, for example, as a concave surface, and a portion of the fastening device 30 (i.e., a portion that is brought into contact with the contact surface 21) may be formed so as to be a convex surface that mates with the concave surface, so that the feature of autonomous position alignment or center adjustment can be attained when the fastening device 30 is pressed against the contact surface 21. Although not shown in the drawings, a converse structure may also be used, i.e., the contact surface 21 may be configured as a convex surface and a portion of the fastening device 30 (i.e., a portion that is brought into contact with the contact surface 21) may be formed as a concave surface that mates with the convex surface. Alternatively, the contact surface 21 may be configured as a convex surface, while a portion of the fastening device 30 (i.e., a portion that is brought into contact with the contact surface 21) may be a flat surface. In the latter case, the contact position between the fastening device 30 and the contact surface 21 is less likely to be affected by manufacturing tolerance, and the core member 20 can be fastened at a position as designed with a high degree of accuracy.

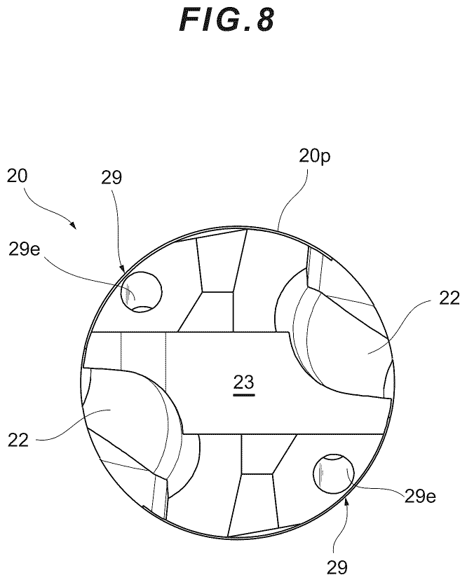

The helical groove 22 is a groove formed in a helical shape on the outer surface of the core member 20. The core member 20 of the present embodiment has a pair of helical grooves 22 on the outer surface 20p, and such two grooves 22 are axially symmetrical around the central axis 20x (see FIG. 8, etc.). Further, the helical groove 22 is formed so as to smoothly join to, or to generate a smoothly connecting surface with, the chip discharge groove 14 of the tool body 10, when the core member 20 is fitted in the core fitting part 11 (see FIG. 2, etc.). With this configuration, along with the form of the chip discharge groove 14 having no steps therein, there will not be any obstacle when removing chips, thereby leading to enhanced chip discharge capability.

The insert seat 23 is provided at the leading end portion 20t of the core member 20 such that a cutting insert 40 is mounted on the insert seat 23 along the central axis 20x (see FIG. 4A, etc.). A screw hole 23h is formed near the insert seat 23 so that a fastening screw 23s for fastening the cutting insert 40 is inserted through the hole 23h. The cutting insert 40 that is mounted on the insert seat 23 along the central axis 20x as described above functions as the center cutting edge of the drilling tool 1. It should be noted that a rake surface 41 and a flank 42 are formed at the leading end side of such cutting insert 40 serving as the center cutting edge of the drilling tool 1, and a cutting edge 43 is formed at the intersecting edge between the rake surface 41 and the flank 42, wherein the rake surface 41 faces forward in the tool rotating direction, and the flank 42 faces in the direction of the central axis 10x and extends away from the leading end as it goes rearward in the tool rotating direction (see FIGS. 4A and 4B). The example described herein explains the configuration that has a single insert seat 23 at a position corresponding to the center of the drilling tool 1; however, other configurations may also be employed. For example, although not shown in the drawings, a plurality of insert seats 23 may be arranged around the central axis 20x and an indexable insert may be mounted to such insert seats 23 so as to use the tool as an indexable drill.

The coolant groove 28 is formed at the base end portion 20b of the core member 20. When the core member 20 is fitted in the core fitting part 11 of the tool body 10, the coolant groove 28 communicates with the coolant supply path 18 of the tool body 10, forming a flow path through which coolant flows (see FIG. 6A, etc.). The shape and structure of the coolant groove 28 are not particularly limited, and may, for example, be a single groove or formed of two grooves that intersect in the shape of a cross (see FIG. 7, etc.).

The coolant flow path 29 is a flow path that is formed inside the core member 20 and guides the coolant flowing into the coolant groove 28 toward the leading end portion 20t so as to output the coolant there. The coolant flow path 29 in the core member 20 of the present embodiment is comprised of two flow paths, each running from a portion of the coolant groove 28 (e.g., the bottom surface of the groove 28) through to the coolant exit 29e (see FIGS. 7 and 8, etc.). Such two coolant exits 29e forming a pair are arranged in a manner such that coolant is discharged toward the cutting edge at the leading end of the drilling tool 1 (e.g., the cutting edge of the cutting insert 40 serving as the center cutting edge).

### Fastening Device

The fastening device 30 is used to fasten the core member 20 fitted in the core fitting part 11 of the tool body 10. As described above, a fastening screw is used for the fastening device 30 in the present embodiment (see FIG. 6A, etc.), but this is merely an example of suitable means for fastening the core member 20 and it will obviously be appreciated that other members may also be used instead of a screw. Examples of members that can be used other than a screw may include a biasing member that uses elastic deformation (such as a spring member or a member obtained by deforming a portion of the tool body 10). Further, the configuration of the through-hole 12 may be modified as appropriate according to the configuration of the fastening device 30 (for example, a biasing member may be received in a bottomed hole, rather than a through-hole).

According to the above-described tool body 10, core member 20 and fastening device 30, and the drilling tool 1 constituted by these elements, the fastening device 30 presses the contact surface 21 of the core member 20 in an angled direction relative to a virtual plane VP which is perpendicular to the central axis 20x of the core member 20. Such pressing generates a component of force acting in a direction along the central axis 10x of the tool body 10, or the central axis 20x of the core member 20, thereby allowing the core member 20 to be more firmly and rigidly fastened to the tool body 10. Some conventional drilling tools for making large-diameter holes employ a cartridge-type insert seat for mounting an insert serving as a center cutting edge of the tool, and this configuration can be said to be advantageous compared to tools which do not employ such cartridges, since it allows for an insert seat for the center cutting edge to be selectively replaced if the insert seat is damaged or broken. However, in some cartridge-type drilling tools, a cylindrical component that serves as the center cutting edge may be fastened by the following steps: (i) inserting the component into an insertion hole provided in the center of the drilling tool body at the leading end in the axial direction; (ii) inserting a screw into a screw hole that is provided perpendicular to the central axis of the tool body and extends from the outer surface of the tool body through to the inner surface of the insertion hole; and (iii) using the leading end of such inserted screw to press a flat face of the component, which is formed on the side surface of the component parallel to the central axis of the component. In this fastening method, if force is applied in a direction parallel to the central axis of the component, the tool will have to endure such parallel force with only a frictional force occurring between the inner surface of the insertion hole and the outer surface of the component due to the pressing force applied by the screw. In contrast, the drilling tool 1 according to the present embodiment is advantageous in this respect, as has already been described above. It should be noted that the angle α formed by the central axis 10x of the tool body 10 and the center line 12c of the through-hole 12 may be the same as the angle formed by the central axis 10x and the perpendicular line 21v to the contact surface 21 on a virtual plane defined by such central axis 10x and center line 12c.

Furthermore, the drilling tool 1 of the present embodiment employs a configuration which can be called a two-tier structure in which a replaceable center cutting edge (cutting insert 40) is fitted to the core member 20, and such core member 20 is further fitted to the tool body 10. This configuration helps to prevent the breakage or deformation of the tool body 10 itself, also allows the core member 20 to be firmly and rigidly fastened to the tool body 10, and accordingly facilitates the exertion of stable cutting performance even in machining under highly-efficient conditions or in an unstable state.

The above-described embodiment is an example of a preferred mode of implementation of the present invention; however, the present invention is not limited to the described embodiment and may be modified in various ways without departing from the spirit of the present invention. For example, the drilling tool 1 described in the above embodiment is configured such that the core member 20 is removably attachable to the tool body (drill head) 10 and the center cutting edge (cutting insert 40) is also removable from the core member 20 (i.e., it is a two-tier, indexable cutting tool); however, this is only an example of a preferred configuration, and it will obviously be appreciated that the present invention may also be applied to tools with other structures, such as a brazed-type tool having a brazed tip of cemented carbide, etc. (e.g., a brazed drill or a core member 20, having a cutting edge which is a brazed tip made of cemented carbide or other material for such drill).

The above-described embodiment explains an example in which the present invention is applied to a drilling tool 1; however, this is merely an example of a cutting tool to which the present invention can be applied. In addition to such drilling tools (drills), the present invention may also be applied to, for example, milling tools such as an end mill.

Although the description above has been made by referring to an example of a two-tier-structure cutting tool (drilling tool) as described above, the present invention can obviously also be applied to a cutting tool with a three-tier structure. For example, the core member 20 may be a solid drill in which a drill serving as the center cutting edge is integrally formed at the leading end portion 20t, with one or more cutting inserts arranged in the periphery of the drill (i.e., outward of the center cutting edge), and such core member 20 may further be combined with the tool body 10. The present invention may also be applied to such three-tier-structure cutting tools.

The present invention is suited for use in a tool body of a cutting tool, and a core member for such tool body.

What is claimed is:

1. A core member removably attachable to a tool body of a cutting tool, the core member comprising:
a contact surface which comes into contact with a fastening device for fastening the core member to the tool body,
the contact surface being provided on an outer surface of the core member so as to face outward with an inclination relative to a virtual plane that is perpendicular to a central axis of the core member.

2. The core member according to claim 1, wherein the contact surface is inclined so as to face toward a leading end portion of the core member.

3. The core member according to claim 1, wherein the contact surface is provided on a base end side of the core member.

4. The core member according to claim 1, comprising a helical groove formed on the outer surface.

5. The core member according to claim 1, said core member being cylindrical in shape.

6. The core member according to claim 1, comprising an insert seat provided in the leading end portion of the core member for mounting a cutting insert to the insert seat.

7. The core member according to claim 6, wherein the one or more insert seats are arranged so as to surround the central axis.

8. The core member according to claim 1, wherein the contact surface comes into contact with a fastening device for fastening the core member to the tool body in a state where the core member is fitted into a core fitting part of the tool body along a central axis of the tool body.

9. The core member according to claim 1, wherein the contact surface is formed of a flat surface.

10. The core member according to claim 1, wherein an angle formed by the central axis of the core member and a perpendicular line to the contact surface is 45 degrees or more and less than 90 degrees on a virtual plane defined by the central axis and the perpendicular line.

11. The core member according to claim 1, wherein an angle formed by the central axis of the core member and a perpendicular line to the contact surface is 74 degrees or more and 76 degrees or less on a virtual plane defined by the central axis and the perpendicular line.

12. A tool body of a cutting tool, wherein a cutting insert and a drill are removably attachable to the tool body, the tool body comprising:
a core fitting part into which a core member having a cutting edge is fitted along a central axis of the tool body; and
a fastening device that fastens the core member fitted in the core fitting part to the tool body,
wherein the fastening device presses an outer surface of the core member in an angled direction relative to a virtual plane that is perpendicular to a central axis of the core member.

13. The tool body according to claim 12, further comprising a through-hole through which the fastening device is inserted.

14. The tool body according to claim 13, wherein the through-hole is inclined toward a leading end portion of the tool body as the through-hole extends radially outward of the tool body.

15. The tool body according to claim 12, comprising a helical chip discharge groove formed on an outer surface of the tool body.

16. The tool body according to claim 14, wherein an angle formed by the central axis and a center line of the through-hole is 45 degrees or more and less than 90 degrees on a virtual plane defined by the central axis and the center line.

17. The tool body according to claim 14, wherein an angle formed by the central axis and a center line of the through-hole is 74 degrees or more and 76 degrees or less on a virtual plane defined by the central axis and the center line.

18. The tool body according to claim 12, wherein the core fitting part is provided along the central axis, and a plurality of insert seats are arranged radially outward of the core fitting part.

19. A cutting tool comprising a core member and a tool body,
the core member being removably attachable to the tool body of the cutting tool, the core member comprising:
a contact surface which comes into contact with a fastening device for fastening the core member to the tool body,
the contact surface being provided on an outer surface of the core member so as to face outward with an inclination relative to a virtual plane that is perpendicular to a central axis of the core member; and
the tool body of the cutting tool, wherein a cutting insert and a drill are removably attachable to the tool body, the tool body comprising:
a core fitting part into which the core member having a cutting edge is fitted along a central axis of the tool body; and
the fastening device that fastens the core member fitted in the core fitting part to the tool body,
wherein the fastening device presses the outer surface of the core member in an angled direction relative to a virtual plane perpendicular to the central axis of the core member.
